(19) United States
(12) Patent Application Publication
(10) Pub. No.: US 2005/0156043 A1
(43) Pub. Date: Jul. 21, 2005

(54) Portable security storage hardware with wireless module

(76) Inventor: Hui Lin, Taipei (TW)

Correspondence Address: PRO-TECHTOR INTERNATIONAL, 20775 Norada Court, Saratoga, CA, 95070-3018, US

(21) Appl. No.: 11/032,987

(22) Filed: Jan. 10, 2005

(30) Foreign Application Priority Data
Jan. 15, 2004 (TW) 093101088

(51) Int. Cl. G06K 7/06; G06K 7/08

(52) U.S. Cl. 235/441; 235/451

(57) ABSTRACT

This invention is relates to a portable security storage hardware with wireless module, which comprises a wireless module, a battery pack, a voltage regulator, and a flash memory with IC (Integrated Circuit) card reader. The wireless module can be of any wireless transmission or communication protocol or technique. The battery pack can be as power source of the wireless module, and the flash memory/IC card reader. The voltage regulator can regulate power from battery pack by DC/DC transformation to supply power to the wireless module, and the flash memory/IC card reader. The flash memory and the IC card reader are integrated into IC card identification hardware. No further extra power supply is needed. With no wire or power cord limited, the said security storage hardware with wireless module can be used freer and easier.

### BACKGROUND OF THE INVENTION

1. Field of the Invention

The present invention relates to portable security storage hardware with wireless module, and particularly to convenient portable unity security wireless hardware, which integrates with battery, pack and voltage regulator, so needs no external power supply.

2. Description of the Related Art

Applications of IC card related security mechanism are concrete interface devices, ex. USB (Universal Serial Bus), PS2 (Public Switched 2), IEEE1394 (Institute of Electrical and Electronic Engineers), and PCMCIA (Personal Memory Card International Association), which work by plugging or other concrete connecting. Although most applications are designed to be light and easy to use, like credit card, IC chip could only work with wire or circuit connection.

This limits applications of security mechanism of IC card. IC card or its integrated hardware device can only touch and connect to achieve data transmission and certification.

Wireless should be the way to solve foregoing problem, a non-touching connection of IC card for security mechanism can apply freely and conveniently.

### SUMMARY OF THE INVENTION

This present invention discloses a method that uses wireless module to achieve an IC card-identification-hardware-related security mechanism. Wireless module comprises but not limited IR (Infrared), Bluetooth, RF (Radio Frequency), or IEEE 802.11 series communication protocol or technique, for more transmission speed or higher security level.

IR is a wide applied wireless transmission technique. Any equipment that integrates standard IrDA (Infrared Data Association) device, like computer, printer, notebook, cellular phone, or PDA (Personal Digital Assistant), can communicate and transfer with each other.

Bluetooth contains two main devices, radio sender and radio receiver. Bluetooth integrates said sender and receiver to makes two equipments, which install Bluetooth devices, able to communicate with each other. Data or voice can transfer at 2.45 GHz frequency band at a speed of 1 Mb/s and range of 10 meters. Bluetooth can also set to encrypt and switch frequency at 1,600 times per sec, across obstacle and have no electromagnetic wave jamming, so it is suitable to replace any cord or wire connecting communication or transmission device.

The present invention discloses an integration of a wireless module, a battery pack, a voltage regulator, a flash memory, and an IC card reader, so that can be a portable security storage hardware with wireless module. The wireless module can be any wireless transmission or communication protocol or 5 technique. The battery pack can be as power supply of the wireless module, the flash memory, and the IC card reader. The voltage regulator can regulate power from battery pack by DC/DC transformation to supply power to the wireless module, the flash memory, and the IC card reader. The flash memory and the IC card reader are integrated into IC card identification hardware. With no wire or power cord limited, the said security storage hardware with wireless module can be used freer and easier.

### BRIEF DESCRIPTION OF THE DRAWINGS

FIG. 1 is a diagram illustrating the hardware structure of the present invention.

### DETAILED DESCRIPTION OF THE PREFERRED EMBODIMENTS

In the following description, please refer to the drawings.

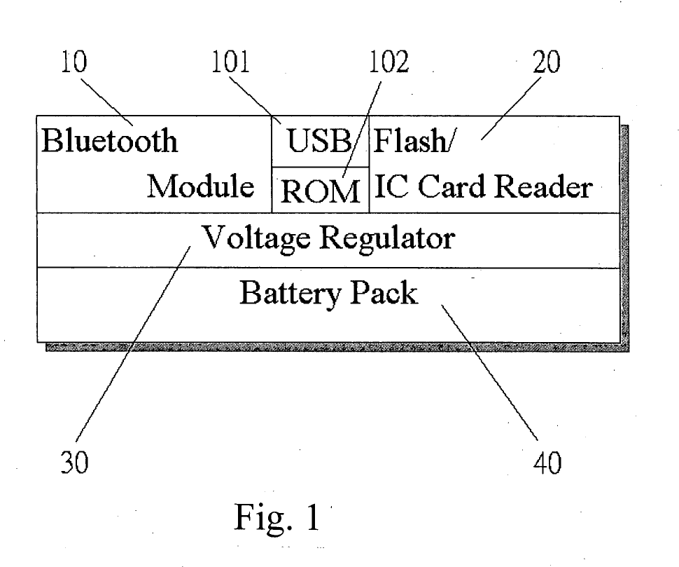

FIG. 1 illustrates the hardware structure of the present invention. The portable security storage hardware with wireless module, which may be Bluetooth module in this example, comprises a Bluetooth module 10, a battery pack 40, a voltage regulator 30, and a flash memory/IC card reader 20. The Bluetooth module 10 is a low power wireless transmission technique, and integrates with USB (Universal Serial Bus) 101 interface and ROM (Read-only Memory) 102, which is supplied for 16 Bit MCU (Microprocessor Control Unit) within Bluetooth module 10 operating program. The flash memory/IC card reader 20 may have USB interface to exchange data with Bluetooth module 10 via its USB 101. The battery pack is power source of the Bluetooth module 10 and the flash memory/IC card reader 20. The voltage regulator transforms DC/DC to supply power to the Bluetooth module 10 and the flash memory/IC card reader 20. The flash memory/IC card reader 20 is as the identification hardware.

The present invention can provide wide-ranged applications of security mechanism of identification hardware with IC card, or apply the present invention as transmission or identification apparatus suit. Cellular phone, PDA, notebook, or desktop computer can use the present invention to transfer wirelessly each other in short range, and also provide high level security and more convenience. The foregoing describing of the preferred embodiment of the invention is for the purposes of illustration and description. It is not intended to exhaustive descript or to limit the invention to the precise from disclosed. Many other possible modifications and variations can be made without departing from the scope of the present invention, which the following claims are depended.

1. A portable security storage hardware with wireless module, comprising a wireless module, which supplies wireless transmission protocol and technique; a flash memory/IC card reader, which is an identification hardware with IC card; characterized in that said portable security storage hardware with wireless module is free from connecting wire or cord in transmission and communication with computer.

2. The portable security storage hardware with wireless module according to claim 1, wherein the wireless module is an infrared transmission module, with standard IrDA infrared port.

3. The portable security storage hardware with wireless module according to claim 1, wherein the wireless module is a Bluetooth module.

4. The portable security storage hardware with wireless module according to claim 3, wherein the Bluetooth module and master Bluetooth module transfer with HIS (Host controller interface) and other protocols.

5. The portable security storage hardware with wireless module according to claim 3, wherein the Bluetooth module comprises USB interface.

6. The portable security storage hardware with wireless module according to claim 3, wherein the Bluetooth module comprises ROM.

7. The portable security storage hardware with wireless module according to claim 1, wherein the wireless module supports Wi-Fi (Wireless Fidelity) protocol.

8. The portable security storage hardware with wireless module according to claim 1, wherein the wireless module supports IEEE 802.1x protocols

9. The portable security storage hardware with wireless module according to claim 1, comprising a battery pack, which is power source of said wireless module and said flash memory/IC card reader.

10. The portable security storage hardware with wireless module according to claim 1, comprising a voltage regulator, which transforms the said battery pack DC/DC to supply power to said wireless module and said flash memory/IC card reader.

11. The portable security storage hardware with wireless module according to claim 9, wherein the battery pack is a self-power-supply with no extra external power source connecting by cord or interface.

12. The portable security storage hardware with wireless module according to claim 10, wherein the voltage regulator is a self-power-supply with no extra external power source connecting by cord or interface.
